(19) United States
(12) Patent Application Publication
(10) Pub. No.: US 2024/0276105 A1
(43) Pub. Date: Aug. 15, 2024

(54) IMAGING ELEMENT AND IMAGING DEVICE

(71) Applicant: NIKON CORPORATION, Tokyo (JP)

(72) Inventor: Haruka OTA, Tokyo (JP)

(73) Assignee: NIKON CORPORATION, Tokyo (JP)

(21) Appl. No.: 18/563,593

(22) PCT Filed: May 23, 2022
(86) PCT No.: PCT/JP2022/021043

§ 371 Date: Nov. 22, 2023

(30) Foreign Application Priority Data
May 24, 2021 (JP) 2021-087030

(51) Int. Cl. H04N 23/80; H04N 25/78

(52) U.S. Cl. CPC H04N 23/80; H04N 25/78

(57) ABSTRACT

An imaging element includes a first substrate having a plurality of pixels configured to output a signal based on photoelectrically converted electric charge, a second substrate having a conversion unit configured to convert a first signal output from at least a first pixel among the plurality of pixels and a second signal output from the first pixel after the first signal into a digital signal, and a third substrate having a calculation unit configured to perform a calculation of an evaluation value based on the first signal converted into a digital signal by the conversion unit and generation of an image signal based on the first signal converted into a digital signal by the conversion unit and the second signal converted into a digital signal by the conversion unit.

### TECHNICAL FIELD

The present invention relates to an imaging element and an imaging device.

Priority is claimed on Japanese Patent Application No. 2021-087030 filed on May 24, 2021, the content of which is incorporated herein by reference.

### BACKGROUND ART

Image data captured by an image sensor is read to an external circuit, which is called an image processing engine, or the like to be used for signal processing or the like. A processing time for outputting data from the image sensor becomes longer as the amount of image data sent from the image sensor to the external circuit or the like increases.

### CITATION LIST

### Patent Document

### [Patent Document 1]

Japanese Unexamined Patent Application, First Publication No. 2011-30097

### SUMMARY OF INVENTION

An imaging element according to a first aspect of the present invention includes a first substrate having a plurality of pixels configured to output a signal based on photoelectrically converted electric charge, a second substrate having a conversion unit configured to convert a first signal output from at least a first pixel among the plurality of pixels and a second signal output from the first pixel after the first signal into a digital signal, and a third substrate having a calculation unit configured to perform a calculation of an evaluation value based on the first signal converted into a digital signal by the conversion unit and generation of an image signal based on the first signal converted into a digital signal by the conversion unit and the second signal converted into a digital signal by the conversion unit.

An imaging device according to a second aspect of the present invention includes the imaging element according to the first aspect.

### BRIEF DESCRIPTION OF DRAWINGS

FIG. 1 is a block diagram illustrating a configuration of an imaging device according to an embodiment.

FIG. 2 is a view illustrating a cross-sectional structure of an imaging element.

FIG. 3 is a block diagram illustrating a configuration of each layer of a first substrate to a fourth substrate in the imaging element.

FIG. 4 is a view illustrating a photographing range imaged by the imaging element.

FIG. 5 is a schematic diagram for explaining transfer of data between the imaging element and an image processing engine according to the embodiment.

FIG. 6 is a schematic diagram for explaining an example of predicting a change in brightness of an image on the basis of a signal included in a focus region.

FIG. 7 is a diagram illustrating an intensity distribution of a pair of object images generated by a pair of light beams for focus detection.

FIG. 8(a) is a diagram illustrating the photographing range and the focus region.

FIG. 8(b) is a schematic diagram for explaining a photoelectric conversion time of a partial image captured in the focus region and a live view image captured in a region other than the focus region.

### DESCRIPTION OF EMBODIMENTS

Hereinafter, an embodiment for implementing the present invention will be described with reference to the drawings.

### <Configuration of Imaging Device>

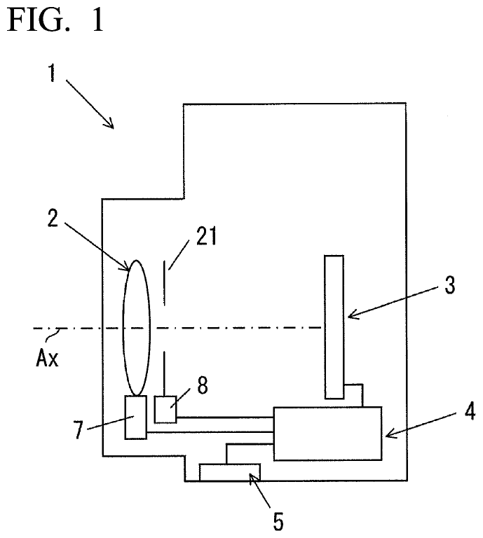

FIG. 1 is a block diagram illustrating a configuration of an imaging device 1 on which an imaging element 3 according to the embodiment is mounted. The imaging device 1 includes a photographing optical system 2 (21), the imaging element 3, a control unit 4, a lens drive unit 7, and an aperture drive unit 8, and is configured to allow a storage medium 5 such as a memory card to be removably attached thereto. The imaging device 1 is, for example, a camera. The photographing optical system 2 has a plurality of lenses and an aperture 21, and forms an object image on the imaging element 3. The imaging element 3 captures an object image formed by the photographing optical system 2 and generates an image signal. The imaging element 3 is, for example, a CMOS image sensor.

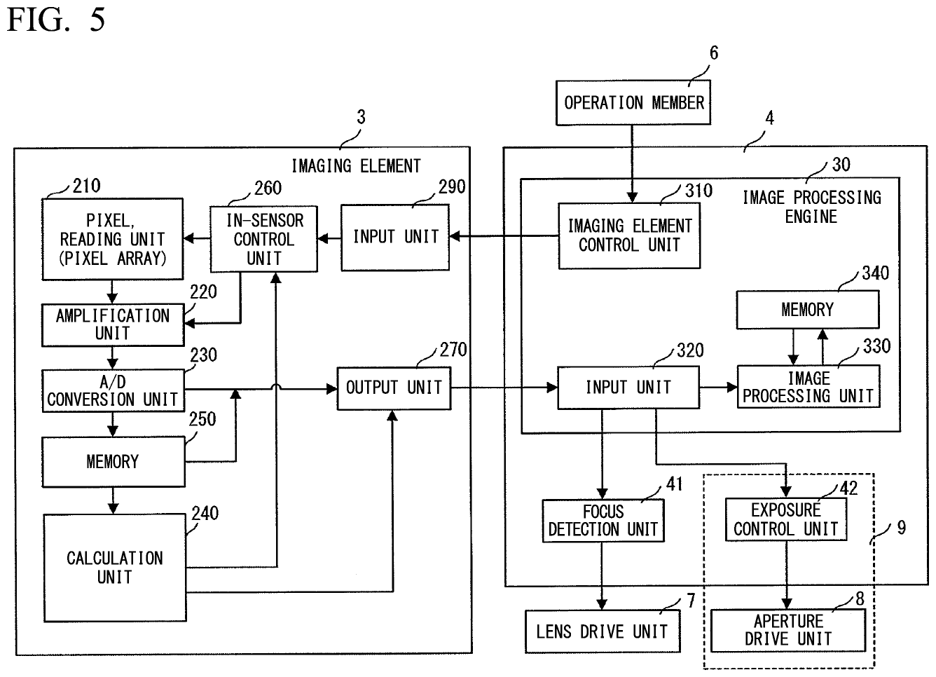

The control unit 4 outputs a control signal for controlling an operation of the imaging element 3 to the imaging element 3. The control unit 4 further functions as an image generation unit that performs various image processing on an image signal output from the imaging element 3 and generates image data. Also, the control unit 4 includes a focus detection unit 41 and an exposure control unit 42 to be described later with reference to FIG. 5. The lens drive unit 7 moves a focusing lens constituting the photographing optical system 2 in a direction of an optical axis Ax to focus on a main object on the basis of a control signal from the control unit 4 (focus detection unit 41). The aperture drive unit 8 adjusts an opening diameter of the aperture 21 to adjust an amount of light incident on the imaging element 3 on the basis of a control signal from the control unit 4 (exposure control unit 42). Image data generated by the control unit 4 is recorded in the storage medium 5 in a predetermined file format.

Further, the photographing optical system 2 may be configured to be removable from the imaging device 1.

### <Cross-Sectional Structure of Imaging Element>

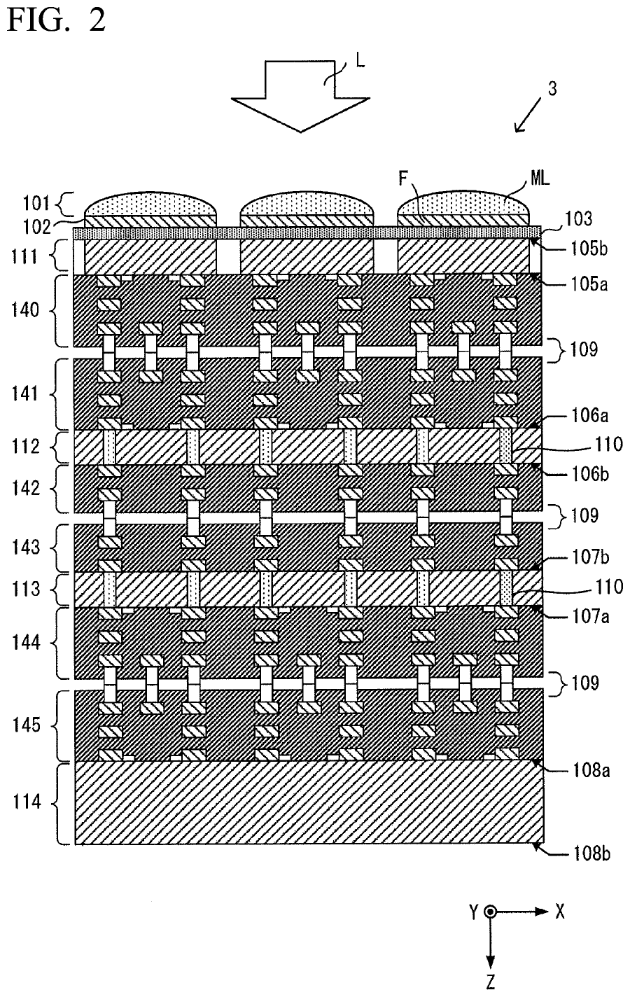

FIG. 2 is a view illustrating a cross-sectional structure of the imaging element 3 of FIG. 1. The imaging element 3 illustrated in FIG. 2 is a back-illuminated imaging element. The imaging element 3 includes a first substrate 111, a second substrate 112, a third substrate 113, and a fourth substrate 114. The first substrate 111, the second substrate 112, the third substrate 113, and the fourth substrate 114 are each formed of a semiconductor substrate or the like. The first substrate 111 is laminated on the second substrate 112 via a wiring layer 140 and a wiring layer 141. The second substrate 112 is laminated on the third substrate 113 via a wiring layer 142 and a wiring layer 143. The third substrate 113 is laminated on the fourth substrate 114 via a wiring layer 144 and a wiring layer 145.

Incident light L illustrated by a white arrow is incident in a Z-axis positive direction. Also, as illustrated in coordinate axes, a rightward direction on the paper surface perpendicular to the Z-axis is defined as an X-axis positive direction, and a forward direction on the paper surface orthogonal to the Z-axis and the-X axis is defined as a Y-axis positive direction. The imaging element 3 includes the first substrate 111, the second substrate 112, the third substrate 113, and the fourth substrate 114 laminated in a direction in which the incident light Lis incident.

The imaging element 3 further includes a microlens layer 101, a color filter layer 102, and a passivation layer 103. These passivation layer 103, color filter layer 102, and microlens layer 101 are sequentially laminated on the first substrate 111.

The microlens layer 101 has a plurality of microlenses ML. The microlens ML focuses the incident light on a photoelectric converter to be described later. The color filter layer 102 has a plurality of color filters F. The passivation layer 103 is formed of a nitride film or an oxide film.

The first substrate 111, the second substrate 112, the third substrate 113, and the fourth substrate 114 respectively have first surfaces 105a, 106a, 107a, and 108a on which gate electrodes and gate insulating films are provided, and second surfaces 105b, 106b, 107b, and 108b that are different from the first surfaces. Also, various elements such as transistors are provided on each of the first surfaces 105a, 106a, 107a, and 108a. The wiring layers 140, 141, 144 and 145 are provided to be laminated on the first surface 105a of the first substrate 111, the first surface 106a of the second substrate 112, the first surface 107a of the third substrate 113, and the first surface 108a of the fourth substrate 114, respectively. Also, the wiring layers (inter-substrate connection layers) 142 and 143 are provided to be laminated on the second surface 106b of the second substrate 112 and the second surface 107b of the third substrate 113, respectively. The wiring layers 140 to 145 are layers each including a conductive film (metal film) and an insulating film, and in each of which a plurality of wirings, vias, and the like are disposed.

Elements on the first surface 105a of the first substrate 111 and elements on the first surface 106a of the second substrate 112 are electrically connected by a connection part 109 such as bumps or electrodes via the wiring layers 140 and 141. Similarly, elements on the first surface 107a of the third substrate 113 and elements on the first surface 108a of the fourth substrate 114 are electrically connected by the connection part 109 such as bumps or electrodes via the wiring layers 144 and 145. Also, the second substrate 112 and the third substrate 113 have a plurality of through electrodes 110. The through electrodes 110 of the second substrate 112 connect circuits provided on the first surface 106a and the second surface 106b of the second substrate 112, and the through electrodes 110 of the third substrate 113 connect circuits provided on the first surface 107a and the second surface 107b of the third substrate 113. Circuits provided on the second surface 106b of the second substrate 112 and circuits provided on the second surface 107b of the third substrate 113 are electrically connected by the connection part 109 such as bumps or electrodes via the inter-substrate connection layers 142 and 143.

Further, a case in which the first substrate 111, the second substrate 112, the third substrate 113, and the fourth substrate 114 are laminated is exemplified in the embodiment, but the number of laminated substrates may be more or less than that of the embodiment.

Also, the first substrate 111, the second substrate 112, the third substrate 113, and the fourth substrate 114 may also be referred to as a first layer, a second layer, a third layer, and a fourth layer.

### <Configuration Example of Imaging Element>

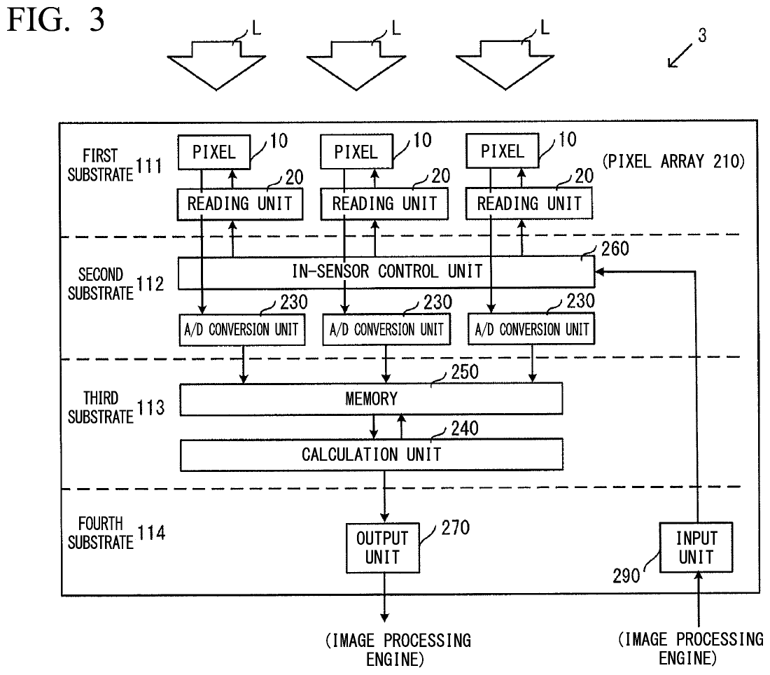

FIG. 3 is a block diagram illustrating a configuration of each layer of the first substrate 111 to the fourth substrate 114 in the imaging element 3 according to the embodiment. The first substrate 111 includes, for example, a plurality of pixels 10 and signal reading units 20 disposed two-dimensionally. The plurality of arranged pixels 10 and reading units 20 may be referred to as a pixel array 210. The pixels 10 are disposed to be aligned in the X-axis direction (row direction) and the Y-axis direction (column direction) illustrated in FIG. 2. Each of the pixels 10 has a photoelectric converter such as a photodiode (PD) to convert the incident light L into electric charge. Each of the reading units 20 is provided for one pixel 10 and reads a signal (photoelectric conversion signal) based on electric charge photoelectrically converted in the corresponding pixel 10. A read control signal necessary for the reading unit 20 to read a signal from the pixel 10 is supplied to the reading unit 20 from an in-sensor control unit 260 of the second substrate 112. The signal read by the reading unit 20 is sent to the second substrate 112.

The second substrate 112 includes, for example, an A/D conversion unit 230 and the in-sensor control unit 260. The A/D conversion unit 230 converts a signal output from the corresponding pixel 10 into a digital signal. The signal converted by the A/D conversion unit 230 is sent to the third substrate 113.

The in-sensor control unit 260 generates a read control signal for the reading units 20 based on an instruction signal input via an input unit 290 of the fourth substrate 114. The instruction signal is sent from an image processing engine 30 to be described later with reference to FIG. 5. The read control signal generated by the in-sensor control unit 260 is sent to the first substrate 111.

The third substrate 113 includes, for example, a memory 250 and a calculation unit 240. The memory 250 stores digital signals converted by the A/D conversion unit 230. The calculation unit 240 performs a predetermined calculation using at least one of the digital signals stored in the memory 250 and the digital signals converted by the A/D conversion unit 230. The calculation includes at least one of calculations exemplified below.
(1) Calculating information indicating a brightness of an image captured by the imaging element 3
(2) Calculating information indicating a state of focus adjustment of the photographing optical system 2
(3) Performing complementary processing on a live view image

The live view image is an image for a monitor display that is generated on the basis of the digital signals converted by the A/D conversion unit 230, and is also referred to as a through image.

The fourth substrate 114 includes, for example, an output unit 270 and the input unit 290. The output unit 270 outputs the digital signals stored in the memory 250, the digital signals converted by the A/D conversion unit 230 described above, or information indicating a calculation result of the calculation unit 240 to the image processing engine 30 (see FIG. 5) to be described later.

An instruction signal from the image processing engine 30 is input to the input unit 290. The instruction signal is sent to the second substrate 112.

### <Focus Point>

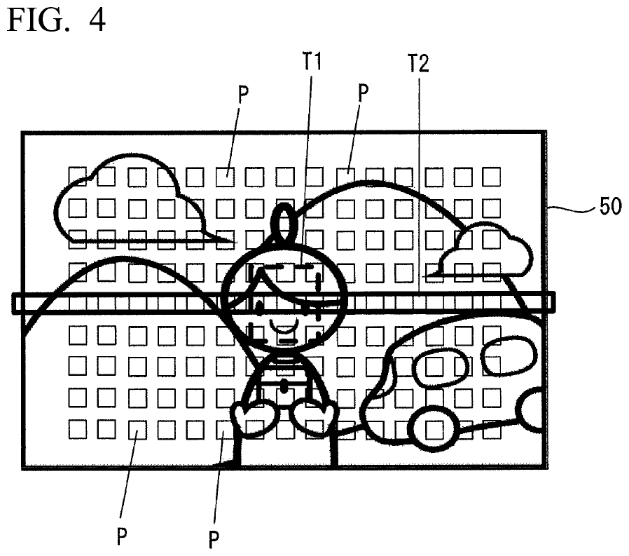

A focus point and a focus region will be described. The pixels 10 forming the pixel array 210 of the imaging element 3 have a photoelectric converter for image generation. However, in a part or all of a region corresponding to a focus point, the pixels 10 having a photoelectric converter for focus detection are disposed instead of the photoelectric converter for image generation. FIG. 4 is a view illustrating a photographing range 50 imaged by the imaging element 3. A plurality of focus points P are provided in advance in the photographing range 50. The focus points P each indicate a position in the photographing range 50 at which focus adjustment of the photographing optical system 2 is possible, and is also referred to as a focus detection area, a focus detection position, or a ranging point. In FIG. 4, quadrangular marks indicating the focus points P are illustrated to be superimposed on the live view image.

Further, the illustrated number of focus points P and positions thereof in the photographing range 50 are merely examples, and are not limited to the aspect illustrated in FIG. 4.

The control unit 4 (focus detection unit 41) calculates an amount of image deviation (phase difference) between a pair of images due to a pair of light beams passing through different regions of the photographing optical system 2 on the basis of the photoelectric conversion signals from the pixels 10 having the photoelectric converter for focus detection. The amount of image deviation can be calculated for each of the focus points P.

The above-described amount of image deviation between the pair of images is a value that serves as a basis for calculating an amount of defocus, which is an amount of deviation between a position of an object image formed by the light beams that have passed through the photographing optical system 2 and a position of an imaging surface of the imaging element 3, and the amount of defocus can be calculated by multiplying the above-described amount of image deviation between the pair of images by a predetermined conversion coefficient.

The control unit 4 (focus detection unit 41) further generates a control signal for moving the focusing lens of the photographing optical system 2 on the basis of, for example, the above-described amount of image deviation between the pair of images calculated at the focus point P corresponding to the object closest to the imaging device 1 among the plurality of focus points P.

Further, control unit 4 (focus detection unit 41) can automatically select the focus point P used for calculating the above-described amount of image deviation (in other words, calculating the amount of defocus) between the pair of images from among all the focus points P, or can also select the focus point P instructed by a user operating an operation member 6 to be described later.

### <Focus Region>

FIG. 4 also illustrates frames indicating focus regions T1 and T2. The focus region T1 surrounded by a broken line is set by the control unit 4. The control unit 4 (exposure control unit 42) sets the focus region T1 at a position including a main object (for example, a person's face), and detects brightness information (Bv value) of the object using signals from the pixels 10 for image generation included in the focus region T1. The control unit 4 (exposure control unit 42) determines an aperture value (Av value), a shutter speed (Tv value), and a sensitivity (Sv value) on the basis of, for example, the Bv value and information on a program line diagram.

The control unit 4 can set a position of a person or the like detected by a known image recognition processing performed on the basis of the live view image data or a position input by the user operating the operation member 6 to be described later as a position of the main object in the photographing range 50. Further, the entire photographing range 50 may be set as the focus region T1.

The focus region T2 surrounded by a solid line is also set by the control unit 4. For example, the control unit 4 (focus detection unit 41) can set the focus region T2 in the row direction (X-axis direction illustrated in FIG. 2) that includes eyes of the person, and calculate the above-described amount of image deviation (phase difference) between the pair of images using signals from the pixels 10 for focus detection included in the focus region T2.

In the pixels 10 forming the pixel array 210 according to the embodiment, a charge accumulation time can be controlled for each of the pixels 10. In other words, signals photographed at different frame rates can be output from each of the pixels 10. Specifically, it is configured such that, while charge accumulation is performed once in a certain pixel 10, charge accumulation is performed a plurality of times in other pixels 10, and thereby signals can be read from each of the pixels 10 at different frame rates.

Also, in the embodiment, an amplification gain for a signal output from the pixels 10 can be controlled for each pixel 10. For example, when an image is captured with different charge accumulation time for each pixel 10 or the like and the signal level read from each pixel 10 is different, the amplification gain can be set such that the signal levels are made uniform.

### <Imaging Element and Image Processing Engine>

FIG. 5 is a schematic diagram for explaining transfer of data or the like between the imaging element 3 and the image processing engine 30 according to the embodiment.

When an instruction signal of capturing an image for recording is input from the image processing engine 30, the imaging element 3 captures the image for recording and sends data of the captured image to the image processing engine 30 as image data for recording. When the image data for recording is sent to the image processing engine 30, for example, the digital signals stored in the memory 250 can be sent as the image data for recording.

When an instruction signal of capturing an image for a monitor display is input from the image processing engine 30, the imaging element 3 captures an image of a plurality of frames for a monitor display, and sends data of the captured image to the image processing engine 30 as live view image data. When the live view image data is sent to the image processing engine 30, for example, the digital signals converted by the A/D conversion unit 230 can be sent as the live view image data.

The imaging element 3 is configured to be able to send information indicating the calculation result of the calculation unit 240 to the image processing engine 30 in addition to the image data.

### <Image Processing Engine>

In the embodiment, the image processing engine 30 is included in the control unit 4. The image processing engine 30 includes an imaging element control unit 310, an input unit 320, an image processing unit 330, and a memory 340.

The operation member 6 including a release button, an operation switch, and the like is provided on, for example, an exterior surface of the imaging device 1. The operation member 6 sends an operation signal according to an operation by the user to the imaging element control unit 310. The user provides a photographing instruction, a setting instruction of photographing conditions or the like to the imaging device 1 by operating the operation member 6.

When a setting instruction of photographing conditions or the like is provided, the imaging element control unit 310 sends information indicating the set photographing conditions to the imaging element 3. Also, when a half-press operation signal, which indicates that the release button has been operated to be half pressed with a stroke shorter than that at the time of a full-press operation, is input from the operation member 6, the imaging element control unit 310 sends an instruction signal instructing a start of capturing an image for a monitor display to the imaging element 3 to continuously display the image for a monitor display on a display unit or a viewfinder (not illustrated).

Furthermore, when a full-press operation signal, which indicates that the release button has been operated to be fully pressed with a stroke longer than that at the time of the half-press operation, is input from the operation member 6, the imaging element control unit 310 sends an instruction signal instructing a start of capturing a still image for recording to the imaging element 3.

The above-described digital signals output from the imaging element 3 or the like are input to the input unit 320. Among the digital signals input to the input unit 320, a digital signal based on a signal from the pixel 10 having the photoelectric converter for image generation is sent to the image processing unit 330. The image processing unit 330 performs predetermined image processing on the digital signals acquired from the imaging element 3 to generate image data. The generated image data for recording is recorded in the memory 340 or used for displaying a confirmation image after capturing the image. The image data recorded in the memory 340 can be recorded in the storage medium 5 described above. Further, the generated image data for a monitor display is used for a display on a viewfinder or the like.

Among the digital signals input to the input unit 320, a live view image signal based on the signal from the pixel 10 having the photoelectric converter for image generation is also sent to the exposure control unit 42 to be used for an exposure calculation. The above-described aperture value, shutter speed, and sensitivity are determined by the exposure calculation.

Among the digital signals input to the input unit 320, a digital signal based on a signal from the pixel 10 having the photoelectric converter for focus detection is sent to the focus detection unit 41 to be used for a focus detection calculation. The amount of defocus described above is calculated by the focus detection calculation.

Also, information indicating a state of the focus adjustment of the photographing optical system 2, which is input to the input unit 320, is used for validity determination of focus adjustment in the control unit 4.

### <Imaging Element>

The imaging element 3 includes an amplification unit 220 in addition to the pixel array 210, the A/D conversion unit 230, the calculation unit 240, the memory 250, the in-sensor control unit 260, the input unit 290, and the output unit 270 described with reference to FIG. 3. The amplification unit 220 can be provided in the first substrate 111 of FIG. 3. The amplification unit 220 amplifies a signal output from the pixel 10 and sends the amplified signal to the A/D conversion unit 220.

In addition to generation of the read control signal for the reading unit 20 described above, the in-sensor control unit 260 performs the following setting processing.

(1) The in-sensor control unit 260 sets an amplification gain for the amplification unit 220 based on information indicating a brightness of an image to be described later. Setting of the amplification gain is possible in units of the pixel 10, and for example, an amplification gain for signals of all the pixels 10 included in the photographing range 50 can be made the same, or an amplification gain for signals of the pixels 10 included in the focus region T1 or T2 described above can be made different from an amplification gain for signals of the other pixels 10.

(2) The in-sensor control unit 260 sets a photoelectric conversion time (in other words, accumulation times) for the pixels 10 in the photographing range 50 on the basis of the information indicating a brightness of the image to be described later. Setting of the photoelectric conversion time is possible in units of the pixel 10, and for example, a photoelectric conversion time of all the pixels 10 included in the photographing range 50 can be made the same, or a photoelectric conversion time of the pixels 10 included in the focus region T1 or T2 described above can be made different from a photoelectric conversion time of the other pixels 10.

### <Processing Performed by Calculation Unit>

The calculation unit 240 can perform the following processing.

### 1. Calculation of Information Indicating Brightness of Image

The calculation unit 240 of the imaging element 3 calculates the information indicating a brightness of the image on the basis of, for example, digital signals output from the pixels 10 having the photoelectric converter for image generation included in the focus region T1 described above and converted by the A/D conversion unit 230. The information calculated by the calculation unit 240 is sent to the in-sensor control unit 260 to be used for the setting processing described above.

Further, information indicating the focus region T1 set by the control unit 4 is transmitted to the imaging element 3 via the image processing engine 30.

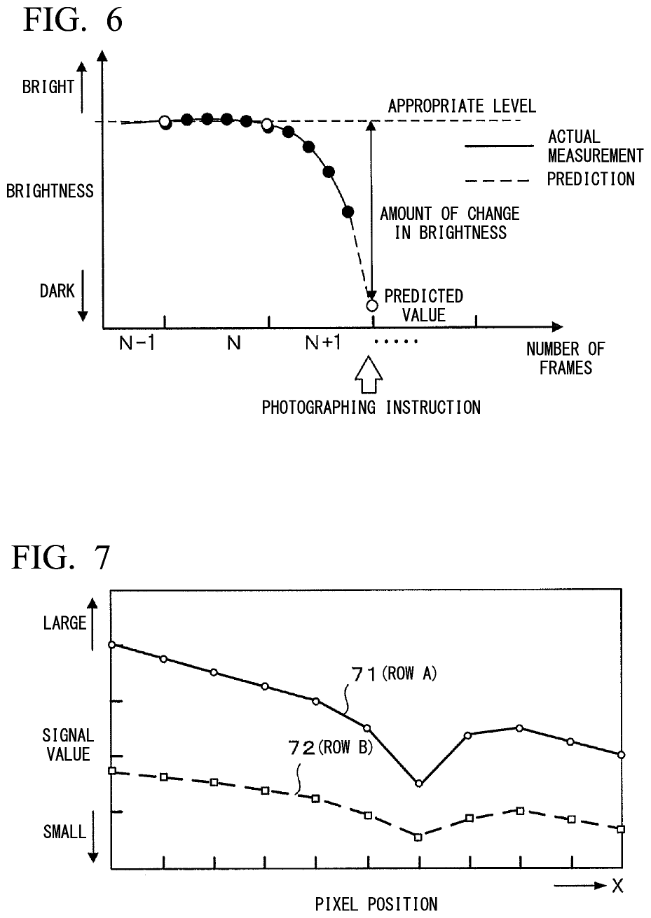

FIG. 6 is a schematic diagram for explaining an example in which the calculation unit 240 predicts a change in brightness of the image on the basis of the signals from the pixels 10 having the photoelectric converter for image generation included in the focus region T1. The horizontal axis represents the number of frames of a live view image, and the vertical axis represents a brightness of an image. In the embodiment, while the live view image is read at a frame rate of 30 frames per second (hereinafter referred to as 30 fps), a partial image in the focus region T1 is read at a high speed equivalent to 150 fps which is five times the frame rate of the live view image. The image in the focus region T1 is called a partial image.

The white circle in FIG. 6 indicates a read timing of the live view image. It is assumed that a most recent N frame and the previous N-1 frame have been read as the live view image. Also, the black circle in FIG. 6 indicates a read timing of the partial image in the focus region T1. While one frame of the live view image is read, five frames of the partial image are read.

For example, the calculation unit 240 calculates an average value of digital signals forming the partial image, and uses the calculated average value as brightness information of the partial image. In the embodiment, while one frame of the live view image is read, the average value of the digital signals forming the partial image can be calculated five times. In the example of FIG. 6, a brightness of the partial image gradually decreases during capturing an N+1-th frame of the live view image. The calculation unit 240 predicts a brightness at the read timing of the N+1-th frame of the live view image using an extrapolation method on the basis of an amount of temporal change in brightness of the partial image.

A predicted value calculated by the calculation unit 240 is used by the in-sensor control unit 260 as follows.

In order to compensate for an amount of change in brightness at the read timing of the N+1-th frame of the live view image predicted by the calculation unit 240 (a difference between the brightness at the read timing of the N-th frame and the predicted value at the read timing of the N+1-th frame), during capturing the N+1-th frame of the live view image, the in-sensor control unit 260 performs the setting processing on the basis of the information indicating a brightness of the image by, for example, increasing the amplification gain for the signals of all the pixels 10 included in the photographing range 50, increasing the photoelectric conversion time of all the pixels 10 included in the photographing range 50, or the like.

Also, if the brightness of the partial image increases during capturing the live view image, in order to compensate for an amount of change in brightness at the read timing of the N+1-th frame of the live view image predicted by the calculation unit 240, during capturing the N+1-th frame of the live view image, the in-sensor control unit 260 performs the setting processing on the basis of the information indicating a brightness of the image by, for example, reducing the amplification gain for the signals of all the pixels 10 included in the photographing range 50, reducing the photoelectric conversion time of all the pixels 10 included in the photographing range 50, or the like.

Similarly, when an operation of a photographing instruction is performed by the user at a timing indicated by the white arrow in FIG. 6, the in-sensor control unit 260 sets at least one of the amplification gain and the photoelectric conversion time at the time of capturing the image for recording to minimize an influence of the change in brightness predicted by the calculation unit 240.

As described above, the in-sensor control unit 260 performs at least one of the gain setting for the amplification unit 220 and the setting of the photoelectric conversion time for the pixels 10 on the basis of the information indicating a brightness of the image calculated by the calculation unit 240. With such a configuration, for example, a feedback control that brings a brightness of the image closer to an appropriate level can be performed within the imaging element 3. Therefore, it is possible to reduce the number of data transmitted between the imaging element 3 and external circuits or the like.

### 2. Calculation of Information Used for Validity Determination of Focus Adjustment

The calculation unit 240 of the imaging element 3 calculates information indicating an intensity distribution of signals from the pixels for focus detection on the basis of, for example, digital signals output from the pixels 10 having the photoelectric converter for focus detection included in the focus region T2 described above and converted by the A/D conversion unit 230. The information calculated by the calculation unit 240 is transmitted to the control unit 4 via the output unit 270 to be used for the validity determination of focus adjustment.

Further, information indicating the focus region T2 set by the control unit 4 is transmitted to the imaging element 3 via the image processing engine 30.

FIG. 7 is a diagram illustrating an intensity distribution of a pair of object images generated by the pair of light beams for focus detection described above. The horizontal axis represents positions of the pixels 10 in the X-axis direction in which the photoelectric converters for focus detection are disposed, and the vertical axis represents a signal value of the digital signal. The pair of light beams described above are referred to as a light beam A and a light beam B, an image generated by the light beam A is represented by a curve 71, and an image generated by the light beam B is represented by a curve 72. That is, the curve 71 is a curve based on signal values read from the pixels 10 that receive the light beam A, and the curve 72 is a curve based on signal values read from the pixels 10 that receive the light beam B.

In the embodiment, while the live view image is read at 30 fps, a partial image in the focus region T2 is read at a high speed equivalent to 150 fps which is five times the frame rate of the live view image. For example, the calculation unit 240 calculates a difference between an average value of digital signal values indicating an intensity distribution of the object image shown by the curve 71 and an average value of digital signal values indicating an intensity distribution of the object image shown by the curve 72. That is, while one frame of the live view image for a monitor display is read, the above-described difference between the average values based on the signals of the partial image can be calculated five times.

The difference between the average values calculated by the calculation unit 240 is sent to the image processing engine 30 (that is, the control unit 4) as the information indicating a state of the focus adjustment of the photographing optical system 2. The difference between the average values calculated by the calculation unit 240 is used by the control unit 4 as follows.

The control unit 4 determines the validity of the focus adjustment on the basis of the information calculated by the calculation unit 240 of the imaging element 3. The example in FIG. 7 is an example in which the signal value shown by the curve 72 is lower than the signal value shown by the curve 71 by an allowable tolerance or more due to a difference in an amount of light between the light beam A and the light beam B for focus detection. When a focus detection calculation processing is performed using the curve 71 and the curve 72 based on the pair of light beam A and light beam B in which there is a difference equal to or more than the allowable tolerance between the curve 71 and the curve 72 as described above, in other words, there is a low degree of coincidence, it is difficult to calculate an amount of image deviation between the pair of object images with high accuracy.

Therefore, when the difference between the average value of the digital signal values shown by the curve 71 and the average value of the digital signal values shown by the curve 72 exceeds a predetermined determination threshold, the control unit 4 determines that the focus adjustment lacks the validity and does not cause the focus detection unit 41 to generate a control signal for moving the focusing lens of the photographing optical system 2. With such a configuration, when the validity of the focus adjustment is determined within a short period of time while one frame of the live view image is captured, and it lacks the validity, it is possible to avoid unnecessary driving of the focusing lens.

Further, in the above-described description, an example in which the control unit 4 determines the validity of the focus adjustment on the basis of the intensity distribution of two object images based on the light beam A and the light beam B has been described, but the control unit 4 may be configured to determine the validity of the focus adjustment on the basis of whether or not a peak value of the intensity distribution of the object image in a row A or row B exceeds the predetermined determination threshold.

In this case, the calculation unit 240 calculates a peak value of the intensity distribution of the object image shown by the curve 71 or the curve 72. The peak value of the intensity distribution of the object image calculated by the calculation unit 240 is sent to the image processing engine 30 (that is, the control unit 4) as the information indicating a state of the focus adjustment of the photographing optical system 2.

If the peak value of the intensity distribution of the object image is lower than the predetermined determination threshold, the control unit 4 determines that the focus adjustment lacks the validity and does not cause the focus detection unit 41 to generate a control signal for moving the focusing lens of the photographing optical system 2.

Also, the control unit 4 may be configured to determine the validity of the focus adjustment on the basis of whether or not peak coordinates of the intensity distribution of the object image in the row A or the row B (in other words, positions in the X-axis direction of the pixels 10 in which the photoelectric converters for focus detection are disposed) are within a predetermined range from a center of the photographing range 50.

In this case, the calculation unit 240 calculates the peak coordinates of the intensity distribution of the object image shown by the curve 71 or the curve 72. The peak coordinates calculated by the calculation unit 240 are sent to the image processing engine 30 (that is, the control unit 4) via the output unit 270 as the information indicating a state of the focus adjustment of the photographing optical system 2.

If the peak coordinates of the intensity distribution of the object image are not included in the predetermined range from the center of the photographing range 50, the control unit 4 determines that the focus adjustment lacks the validity and does not cause the focus detection unit 41 to generate a control signal for moving the focusing lens of the photographing optical system 2.

Furthermore, the control unit 4 may be configured to determine the validity of the focus adjustment on the basis of whether or not a fluctuation range of the intensity distribution of the object image in the row A or the row B is less than a predetermined value (in other words, a contrast of the image is insufficient).

In this case, the calculation unit 240 calculates the fluctuation range on the basis of the intensity distribution of the object image shown by the curve 71 or the curve 72. The fluctuation range calculated by the calculation unit 240 is sent to the image processing engine 30 (that is, the control unit 4) via the output unit 270 as the information indicating a state of the focus adjustment of the photographing optical system 2.

If the fluctuation range of the intensity distribution of the object image is less than the predetermined value, the control unit 4 determines that the focus adjustment lacks the validity and does not cause the focus detection unit 41 to generate a control signal for moving the focusing lens of the photographing optical system 2.

### 3. Complementary Processing

Since the partial image of the focus region T1 is read at a higher frame rate (for example, five times) than the live view image of a region other than the focus region T1, a photoelectric conversion time of the partial image is shorter than that of the live view image (for example. ⅕). Therefore, if the amplification gain for the signal is set to the same level for the live view image and the partial image, a signal level of the partial image per frame is smaller than a signal level of the live view image (for example, ⅕).

The calculation unit 240 of the embodiment performs complementary processing to bring the signal level of the partial image of the focus region T1 closer to the signal level of the live view image. For example, for digital signals from the focus region T1, the digital signals of five frames of the partial images read at a frame rate higher than that of the live view image (for example, five times) are added for each pixel 10, the gain is adjusted as necessary, and then they are embedded in the focus region T1 in the live view image to complement as one live view image.

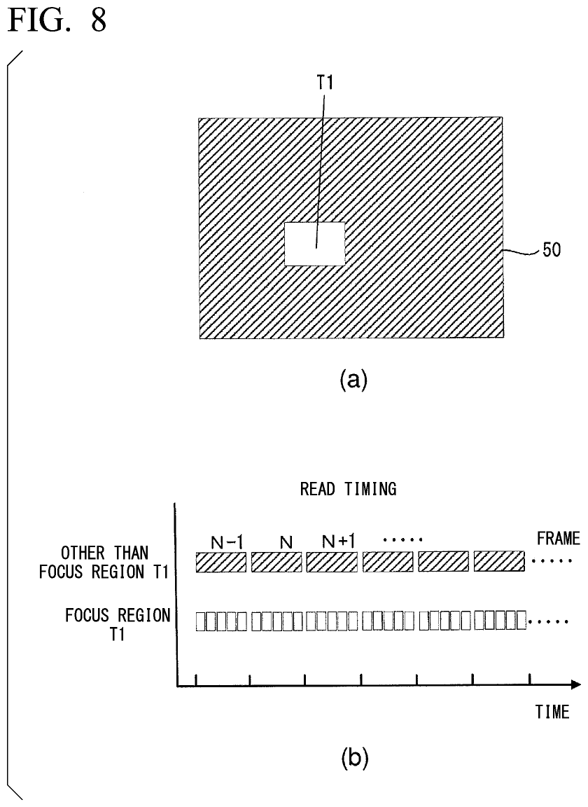

FIG. 8(a) is a diagram illustrating the photographing range 50 and the focus region T1 imaged by the imaging element 3. FIG. 8(b) is a schematic diagram for explaining a photoelectric conversion time of a partial image captured in the focus region T1 and a live view image captured in a region other than the focus region T1. FIG. 8(b) illustrates a case in which five frames of the partial image are read from the focus region T1 while one frame of the live view image is read.

If five frames of the partial image are read from the focus region T1 while one frame of the live view image is read, summing the photoelectric conversion time of the partial image for five frames corresponds to the photoelectric conversion time of one frame of the live view image.

The memory 250 is configured to store digital signals based on the pixels 10 corresponding to the entire photographing range 50 imaged by the imaging element 3 and digital signals based on the pixels 10 corresponding to a part of the photographing range 50 (the focus regions T1 and T2) so that the above-described complementary processing by the calculation unit 240 can be performed.

Also, the memory 250 has a storage capacity capable of storing at least a plurality of frames (for example, 20 frames) of the partial image and at least one frame of the entire image. Since the number of signals forming the partial image is smaller than the number of signals forming the entire image of the photographing range 50, the storage capacity of the memory 250 can be reduced compared to a case in which a plurality of frames of the entire image are stored.

As described above, the calculation unit 240 adds a plurality of frames of the partial image captured at a frame rate higher than that of the live view image in the focus region T1 and uses the signals of the added partial image to complement the live view image captured in a region other than the focus region T1. With such a configuration, the complementary processing of the live view image can be performed within the imaging element 3.

According to the embodiment described above, the following effects can be obtained.

(1) The imaging element 3 includes the plurality of pixels 10 outputting a signal based on photoelectrically converted electric charge, the calculation unit 240 calculating at least one of information indicating a brightness of an image and information used for validity determination of focus adjustment as an evaluation value on the basis of a signal output from the focus region T1 which is a part of the plurality of pixels 10, and the in-sensor control unit 260 controlling at least one of a photoelectric conversion time and an amplification gain for the signal in the pixels 10 of the focus region T1 which is a part of the plurality of pixels 10 on the basis of the evaluation value calculated by the calculation unit 240.

With such a configuration, the number of data or the like output from the imaging element 3 to the image processing engine 30 can be reduced compared to a case in which a signal photoelectrically converted by the imaging element 3 is output to the outside of the imaging element 3 and calculation of the evaluation value is performed by an external image processing engine 30 or the like. Thereby, a processing time for the imaging element 3 to output data or the like and power consumption in the imaging element 3 can be reduced.

Also, a feedback control on at least one of the photoelectric conversion time and the amplification gain for the pixels 10 of the imaging element 3 can be performed within the imaging element 3. Therefore, compared to a case in which a signal photoelectrically converted by the imaging element 3 is output to the outside of the imaging element 3, an evaluation value is calculated by the external image processing engine 30 or the like, and a feedback control of the photoelectric conversion time or the amplification gain based on the evaluation value is performed from the outside of the imaging element 3, the feedback control can be performed in a short period of time because at least a time required for transmitting and receiving data or the like can be omitted.

(2) The calculation unit 240 of the imaging element 3 extrapolates the evaluation value on the basis of a temporal change in the calculated evaluation value.

With such a configuration, the photoelectric conversion time or the amplification gain of the pixels 10 when, for example, a live view image of the next frame is captured can be appropriately controlled.

(3) The signal output from the pixels 10 of the imaging element 3 includes a first signal as the live view image output for a monitor display from all of the plurality of pixels 10 and a second signal as the partial image output for calculation of the evaluation value from the focus region T1 which is a part of the plurality of pixels 10, and the calculation unit 240 calculates the evaluation value on the basis of the second signal.

With such a configuration, the calculation unit 240 can appropriately calculate the evaluation value using the second signal that is output separately from the first signal for a monitor display.

(4) A frame rate at which the second signal is output from the pixels 10 of the imaging element 3 is higher than a frame rate at which the first signal is output.

With such a configuration, the calculation unit 240 can calculate the evaluation value based on the second signal five times while one frame of the live view image (first signal) for a monitor display is read. Therefore, the photoelectric conversion time or the amplification gain for the live view image of the next frame can be appropriately controlled on the basis of the five calculated evaluation values.

(5) The calculation unit 240 of the imaging element 3 adds the second signal forming the partial image output from the pixels 10 of the focus region T1 for, for example, five frames, and uses the added signal to complement the first signal corresponding to the position of the pixel 10 in the focus region T1.

With such a configuration, the complementary processing of the live view image can be appropriately performed within the imaging element 3.

(6) The imaging device 1 includes the imaging element 3, and the control unit 4 determining a validity of focus adjustment of the photographing optical system 2 on the basis of the information output from the imaging element 3 and used for validity determination of focus adjustment as the evaluation value.

As described above, the calculation unit 240 can calculate the information used for the validity determination of focus adjustment five times while one frame of the live view image for a monitor display is read. Therefore, the focus detection unit 41 of the control unit 4 can perform the validity determination of focus adjustment five times faster than when the focus detection calculation is performed using the signal of the focus detection pixel transmitted from the imaging element 3 at the same timing as the signal of the live view image.

### Modified Example 1

In the embodiment described above, an example in which the imaging element 3 has a back-illuminated configuration has been described. Alternatively, the imaging element 3 may have a front-illuminated configuration in which the wiring layer 140 is provided on an incident surface side on which light is incident.

### Modified Example 2

In the embodiments described above, an example in which a photodiode is used as the photoelectric converter has been described. However, a photoelectric conversion film may be used as the photoelectric converter.

### Modified Example 3

The imaging element 3 may be applied to a camera, a smartphone, a tablet, a built-in camera for PC, an in-vehicle camera, and the like.

### Modified Example 4

In the embodiment described above, an example in which the in-sensor control unit 260 sets at least one of the gain setting for the amplification unit 220 and the setting of the photoelectric conversion time for the pixels 10 on the basis of the information indicating a brightness of the image calculated by the calculation unit 240 has been described.

Instead, it may be configured such that the information indicating a brightness of the image calculated by the calculation unit 240 is sent to the control unit 4, the exposure control unit 42 of the control unit 4 performs an exposure calculation on the basis of the information indicating a brightness of the image, and the control unit 4 controls the aperture drive unit 8 on the basis of the exposure calculation result.

In modified example 4, the information indicating a brightness of the image calculated by the calculation unit 240 is sent to the image processing engine 30 (for example, the control unit 4) via the output unit 270. The exposure control unit 42 of the control unit 4 performs the exposure calculation on the basis of the information sent from the imaging element 3 to control the above-described aperture value, shutter speed, and sensitivity. Further, the exposure control unit 42 and the aperture drive unit 8 may be collectively referred to as a light amount adjustment unit 9 (FIG. 5) for adjusting an amount of light incident on the imaging element 3.

As described above, the calculation unit 240 can calculate the information indicating a brightness of the image five times while one frame of the live view image for a monitor display is read. Therefore, when the exposure control unit 42 of the control unit 4 performs the exposure calculation using the information indicating a brightness of the image calculated by the calculation unit 240, the exposure calculation can be performed five times faster than when the exposure calculation is performed using the signal of the live view image sent from the imaging element 3, and thereby an ability to follow a change in brightness of the image can be enhanced.

Further, the number of times the information indicating a brightness of the image calculated by the calculation unit 240 is sent to the image processing engine 30 (that is, the control unit 4) increases in modified example 4, since the information indicating a brightness of the image calculated by the calculation unit 240 has a sufficiently small number of signals compared to the number of signals forming the live view image, the number of data or the like sent from the imaging element 3 to the control unit 4 does not increase significantly.

### Modified Example 5

In the embodiment described above, an example in which the control unit 4 performs the validity determination of focus adjustment on the basis of the information calculated by the calculation unit 240 has been described.

Instead, it may be configured such that the information indicating the intensity distribution of the pair of object images generated by the pair of light beams for focus detection, which is calculated by the calculation unit 240, is sent to the control unit 4, and the focus detection unit 41 of the control unit 4 performs the focus detection calculation on the basis of the information indicating the intensity distribution of the pair of object images to calculate an amount of defocus.

In modified example 5, the information indicating the intensity distribution of the pair of object images generated by the pair of light beams for focus detection, which is calculated by the calculation unit 240, is sent to the image processing engine 30 (that is, the control unit 4) via the output unit 270. The focus detection unit 41 of the control unit 4 performs the focus detection calculation on the basis of the information sent from the imaging element 3 and sends a control signal for moving the focusing lens to the lens drive unit 7.

As described above, the calculation unit 240 can calculate the intensity distribution of the pair of object images five times while one frame of the live view image for a monitor display is read. Therefore, when the focus detection unit 41 of the control unit 4 performs the focus detection calculation using the information indicating the intensity distribution of the pair of object images calculated by the calculation unit 240, the calculation can be performed five times faster than when the focus detection calculation is performed using the signal of the focus detection pixel transmitted from the imaging element 3 at the same timing as the signal of the live view image, and thereby an ability to follow a change in distance of the object can be enhanced.

Further, the number of times the information indicating the intensity distribution of the pair of object images calculated by the calculation unit 240 is sent to the image processing engine 30 (that is, the control unit 4) increases in modified example 5, since the information indicating the intensity distribution of the pair of object images calculated by the calculation unit 240 has a sufficiently small number of signals compared to the number of signals forming the live view image, the number of data or the like sent from the imaging element 3 to the control unit 4 does not increase significantly.

The present invention is not limited to the contents of the embodiment and modified examples. Aspects in which configurations illustrated in the embodiment and modified examples are used in combination are also included within the scope of the present invention. Other aspects conceivable within the scope of the technical idea of the present invention are also included within the scope of the present invention.

### REFERENCE SIGNS LIST

1 Imaging device
3 Imaging element
4 Control unit
7 Lens drive unit
8 Aperture drive unit
9 Light amount adjustment unit
10 Pixel
20 Reading unit
30 Image processing engine
41 Focus detection unit
42 Exposure control unit
60 Region
210 Pixel array
240 Calculation unit
250 Memory
260 In-sensor control unit
270 Output unit
T1, T2 Focus region

1. An imaging element comprising:
a first substrate including a plurality of pixels configured to output a signal based on photoelectrically converted electric charge;
a second substrate including a conversion unit configured to convert a first signal output from at least a first pixel among the plurality of pixels and a second signal output from the first pixel after the first signal into a digital signal; and
a third substrate including a calculation unit configured to perform a calculation of an evaluation value based on the first signal converted into a digital signal by the conversion unit and generation of an image signal based on the first signal converted into a digital signal by the conversion unit and the second signal converted into a digital signal by the conversion unit.

2. The imaging element according to claim 1, wherein the second substrate includes a control unit configured to control a photoelectric conversion time of the first pixel using the evaluation value based on the first signal.

3. The imaging element according to claim 2, wherein
the calculation unit calculates an evaluation value based on the second signal converted into a digital signal by the conversion unit, and
the control unit controls the photoelectric conversion time of the first pixel using the evaluation value based on the first signal and the evaluation value based on the second signal.

4. The imaging element according to claim 3, wherein
the calculation unit predicts the photoelectric conversion time of the first pixel from the evaluation value based on the first signal and the evaluation value based on the second signal, and
the control unit controls the first pixel to have the photoelectric conversion time predicted by the calculation unit.

5. The imaging element according to claim 2, wherein the control unit controls a frame rate of the first pixel to be higher than a frame rate of a second pixel for generating a live view image among the plurality of pixels.

6. The imaging element according to claim 2, wherein the control unit controls the photoelectric conversion time of the first pixel to be shorter than a photoelectric conversion time of the second pixel for generating a live view image among the plurality of pixels.

7. The imaging element according to claim 1, comprising an amplification unit configured to amplify a signal output from the first pixel, wherein
the second substrate includes a control unit configured to control an amplification gain of the amplification unit using the evaluation value based on the first signal.

8. The imaging element according to claim 7, wherein
the calculation unit calculates an evaluation value based on the second signal converted into a digital signal by the conversion unit, and
the control unit controls the amplification gain of the amplification unit using the evaluation value based on the first signal and an evaluation value based on the second signal.

9. The imaging element according to claim 8, wherein
the calculation unit predicts the amplification gain of the amplification unit from the evaluation value based on the first signal and the evaluation value based on the second signal, and
the control unit controls the amplification unit to have the amplification gain predicted by the calculation unit.

10. The imaging element according to claim 7, wherein the control unit controls a frame rate of the first pixel to be higher than a frame rate of a second pixel for generating a live view image among the plurality of pixels.

11. The imaging element according to claim 7, wherein the control unit controls the photoelectric conversion time of the first pixel to be shorter than a photoelectric conversion time of the second pixel for generating a live view image among the plurality of pixels.

12. The imaging element according to claim 1, wherein the calculation unit calculates an evaluation value for determining a validity of focus adjustment of an optical system in which light is incident on the plurality of pixels on the basis of the first signal converted into a digital signal by the conversion unit.

13. The imaging element according to claim 1, wherein the calculation unit generates the image signal by adding the first signal converted into a digital signal by the conversion unit and the second signal converted into a digital signal by the conversion unit.

14. The imaging element according to claim 1, wherein
the conversion unit converts a third signal output from the first pixel after the second signal into a digital signal, and
the calculation unit generates the image signal on the basis of the first signal converted into a digital signal by the conversion unit, the second signal converted into a digital signal by the conversion unit, and the third signal converted into a digital signal by the conversion unit.

15. The imaging element according claim 14, wherein the calculation unit generates the image signal by adding the first signal converted into a digital signal by the conversion unit, the second signal converted into a digital signal by the conversion unit, and the third signal converted into a digital signal by the conversion unit.

16. The imaging element according to claim 1, comprising a fourth substrate including an output unit for outputting the image signal generated by the calculation unit to the outside.

17. An imaging device comprising the imaging element according to claim 1.

18. The imaging device according to claim 17, comprising an image processing unit configured to generate image data by performing image processing on the image signal.

19. The imaging device according to claim 18, comprising a display unit configured to display an image based on the image data.
